(19) United States
(12) Patent Application Publication
(10) Pub. No.: US 2020/0006748 A1
(43) Pub. Date: Jan. 2, 2020

(54) POSITIVE ELECTRODE ACTIVE MATERIAL FOR LITHIUM ION SECONDARY BATTERY

(71) Applicant: MURATA MANUFACTURING CO., LTD., Kyoto (JP)

(72) Inventors: Yuli LI, Kyoto (JP); Jixian LV, Kyoto (JP)

(21) Appl. No.: 16/446,033

(22) Filed: Jun. 19, 2019

(30) Foreign Application Priority Data
Jun. 27, 2018 (CN) 201810681955.6

(51) Int. Cl. H01M 4/131; H01M 10/0525

(52) U.S. Cl. CPC H01M 4/131; H01M 2004/028; H01M 10/0525

(57) ABSTRACT

The present disclosure provides a positive electrode active material for a lithium ion secondary battery. The positive electrode active material includes a material represented by LiCo_{(1-α-β)}A_{(α)}B_{(β)}O₂, wherein the material is configured to have good cycling performance and thermal stability at high charging voltages, and to inhibit expansion of the secondary battery. The present disclosure further provides a positive electrode and a secondary battery using the same positive electrode active material.

### CROSS REFERENCE TO RELATED APPLICATIONS

The present application claims priority to Chinese Patent Application No. 201810681955.6 filed on Jun. 27, 2018, the entire contents of which are being incorporated herein by reference.

### BACKGROUND

The present disclosure generally relates to a positive electrode active material for a lithium ion secondary battery, and a positive electrode sheet and a lithium ion secondary battery using the positive electrode active material. In particular, the present disclosure relates to a positive electrode active material for a lithium ion secondary battery having good cycling performance and thermal stability at high charging voltages and capable of inhibiting expansion of the secondary battery, and a positive electrode sheet and a lithium ion secondary battery using the positive electrode active material.

Nowadays, owing to high energy density, high operating voltage, large number of cycles, no memory effect, environmental friendliness, among other advantages, lithium ion secondary batteries are widely used in portable electronic devices such as mobile phones, notebook computers, digital cameras and the like, and in electric vehicles. Currently available positive electrode materials have smaller capacities than negative electrode materials. Hence, there is an urgent need to develop a new positive electrode material. Among the common positive electrode materials (e.g. lithium cobalt oxide LiCoO₂, lithium nickel oxide LiNiO₂, lithium manganese oxide LiMn₂O₄, and lithium iron phosphate LiFePO₄) for lithium ion batteries, only lithium cobalt oxide is massively produced industrially in a real sense because of its simple and practicable synthetic process, high specific capacity and good cycling performance.

The parameter used to characterize the energy storing capability of a lithium ion secondary battery is energy density which is approximately equal to a product of voltage and battery capacity numerically. In order to effectively increase the amount of electricity stored in a lithium ion battery, the measure that is generally adopted is to increase the battery capacity. However, to further miniaturize the device that uses the battery, it's undesirable to increase the amount of electricity that is stored in the battery by increasing the capacity. Therefore, increasing the charging voltage is an alternative effective way to further increase the energy density of the lithium ion secondary battery. The cut-off charging voltage of most existing lithium ion secondary batteries is in the range of 3.0-4.3 V, wherein the discharge specific capacity is about 140 m Ah/g. If the charging voltage is about 4.5 V, the discharge specific capacity of a lithium ion secondary battery with lithium cobalt oxide as a positive electrode material may be increased significantly by about 20%.

However, as the case stands, simply increasing the charging voltage of a battery will, on the one hand, cause excessive deintercalation of lithium from lithium cobalt oxide, such that the lithium-lean hexagonal phase structure becomes unstable and very susceptible to destruction, while lithium ions turn from order to disorder, closely followed by transformation of crystal cells from a hexagonal phase to a monoclinic phase. The generation of the monoclinic phase will lead to a sharp attenuation of the battery capacity. On the other hand, Co³⁺ in the LiCoO₂ structure will be oxidized into strongly oxidative Co⁴⁺ which will accelerate the reaction between Co ions and the electrolyte. Put another way, Co is dissolved. As a result of the above phenomena, the cycling performance of the battery will decrease notably, and the thermal stability of the battery will become poor, such that the battery will expand, leading to a safety problem.

Therefore, there is an urgent need for a positive electrode active material for a lithium ion secondary battery, wherein the positive electrode active material has good cycling performance and thermal stability at high charging voltages, and is capable of inhibiting expansion of the secondary battery.

Generally, the performances of a positive electrode active material can be improved by modifying bulk doping of positive electrode active particles.

### SUMMARY

The present disclosure generally relates to a positive electrode active material for a lithium ion secondary battery, and a positive electrode sheet and a lithium ion secondary battery using the positive electrode active material. In particular, the present disclosure relates to a positive electrode active material for a lithium ion secondary battery having good cycling performance and thermal stability at high charging voltages and capable of inhibiting expansion of the secondary battery, and a positive electrode sheet and a lithium ion secondary battery using the positive electrode active material.

In view of the above problems, one object of the present disclosure is to provide a positive electrode active material for a lithium ion secondary battery, wherein the positive electrode active material has good cycling performance and thermal stability at high charging voltages, and is capable of inhibiting expansion of the secondary battery.

Another object of the present disclosure is to provide a positive electrode sheet and a lithium ion secondary battery using the above positive electrode active material for a lithium ion secondary battery.

According to an embodiment of the present disclosure, a positive electrode active material for a lithium ion secondary battery is provided. The positive electrode active material includes a material represented by LiCo_{(1-α-β)}A_{(α)}B_{(β)}O₂, wherein element A is selected from the group consisting of Mg, Sc, Ti, Fe, Ni, Cu, Zn, Ga, Zr, Nb, Mo, Ru, Rh, Pd, In, Sn, Hf, Ta, W, Re, Cr, Y, Sb, Lu, Au, Pb, Er and combinations thereof, and element B is selected from the group consisting of Na, Al, Si, Ge, Mn, Ca, Te, Hg, Bi, La, Ce, Pr, Nd, Sm, V and combinations thereof; a difference between an ionic radius of the element A and an ionic radius of lithium is equal to or less than 20%, and a difference between an ionic radius of the element B and the ionic radius of lithium is equal to or more than 25%; a total doping amount (α+β) of the elements A and B satisfies 0.1 mol %≤α+β≤8 mol %, a doping amount α of the element A satisfies 0.05 mol %≤α≤5 mol %, and a doping amount β of the element B satisfies 0.05 mol %≤β≤5 mol %; an average valence of the element A is from 1.5 to 3.5, and an average valence of the element B is from 2.0 to 4.0; the element A is uniformly distributed in particles of the positive electrode active material; and the element B has a higher concentration on a surface of the particles than an inside of the particles.

According to an embodiment of the present disclosure, a positive electrode using the positive electrode active material for a lithium ion secondary battery as described herein is provided.

According to an embodiment of the present disclosure, a lithium ion secondary battery using the positive electrode active material as described herein is provided.

According to an embodiment of the present disclosure, a method of manufacturing a positive electrode active material for a lithium ion secondary battery is provided. The method comprises steps of: reacting a cobalt source and an element B source with a precipitant solution to obtain a positive electrode active material precursor, wherein a concentration distribution of the element B is regulated by varying a feeding rate of the element B source; mixing the above precursor with lithium carbonate and an element A source, followed by calcination and sieving treatment to obtain a positive electrode active material lithium cobalt oxide.

According to an embodiment of the present disclosure, there will be provided a positive electrode active material for a lithium ion secondary battery having good cycling performance and thermal stability at high voltages and capable of inhibiting expansion of the secondary battery, and a positive electrode sheet and a lithium ion secondary battery using the above positive electrode active material.

The advantageous effects mentioned in the present description are for illustrative purpose only and are not limited to the above-mentioned effects, and other suitable properties relating to the present technology may be realized and as further described

### DETAILED DESCRIPTION

As described herein, the present disclosure will be described based on examples with reference to the drawings, but the present disclosure is not to be considered limited to the examples, and various numerical values and materials in the examples are considered by way of example.

The positive electrode active material of the present disclosure is a material represented by LiCo_{(1-α-β)}A_{(α)}B_{(β)}O₂. By selecting the types, ionic radii, valences and doping manners of the doping elements A and B, a positive electrode active material for a lithium ion secondary battery having good cycling performance and thermal stability at high voltages and capable of inhibiting expansion of the secondary battery can be obtained.

The charge and discharge process of a lithium ion secondary battery is virtually a process of deintercalation and intercalation of lithium ions. At present, for a positive electrode active material for a lithium ion secondary battery using lithium cobalt oxide as a main component, layered LiCoO₂ is used in most cases because of its relatively stable structure. Its theoretical capacity is 274 mAh/g, but the real capacity up to now is only 145 mAh/g. Hence, there is still large room for development. In ideal layered LiCoO₂, Li⁺ and Co³⁺ are alternately situated at octahedral positions in cubic close-packed oxygen layers. But in fact, as Li⁺ and Co³⁺ apply different forces on the oxygen layers, the distribution of oxygen atoms does not conform to the ideal close packed structure, but deviates to exhibit a trigonal symmetry. In the charge and discharge process, Li⁺ is reversibly deintercalated from or intercalated into a plane in which it resides, wherein the immigration of lithium ions in the positive electrode active material may be represented by the following formulas:

LiCoO₂→xLi⁺+Li₁₋ₓCoO₂+xe⁻ Charge:

Li₁₋ₓCoO₂+yLi⁺+xe⁻→Li₁₋ₓ+yCoO₂ (0<x≤1, 0<y≤x) Discharge:

During charge, lithium ion is deintercalated from an octahedral position, an electron is released, and Co³⁺ is oxidized to Co⁴⁺; during discharge, lithium ion is intercalated to an octahedral position, an electron is obtained, and Co⁴⁺ is reduced to Co³⁺.

The real specific capacity of lithium cobalt oxide is lower than the theoretical specific capacity. After a number of charge-discharge cycles, the phase structure of the positive electrode active material is altered due to several times of contraction and expansion, such that LiCoO₂ becomes loose or even falls off, the internal resistance increases, and the capacity decreases. The reason is as follows: since LiCoO₂ is a compound with lithium ions intercalated, if more than a half of the lithium ions are deintercalated from LiCoO₂ during charge, the crystalline form of LiCoO₂ will change, and LiCoO₂ will no longer have the function of deintercalation/intercalation of lithium ions.

In the past, attempts have been made to improve the characteristics of lithium ion secondary batteries by bulk doping. However, at higher charging voltages (≥4.40V), the functions of the various elements that are added are not fully understood in the prior art, and a balance between the various performances such as cycling, thermal stability, expansion and the like cannot be achieved.

The present inventors have discovered that, by doping lithium cobalt oxide with two different types of elements, the influence on the normal deintercalation and intercalation of Li is minimized while collapse of the phase structure is prevented, such that the cycling performance, thermal stability and inhibition of expansion are well balanced.

In the present disclosure, the element A moves to the position of Li in the charge and discharge process to prevent collapse of the structure and improve the thermal stability. Nevertheless, the element A may affect deintercalation of lithium, and in turn, deteriorate the cycling characteristic. The element B will not move to the position of Li in the process of charge and discharge, and acts to stabilize the crystalline structure. Meanwhile, the element B is able to improve the cycling characteristic, and inhibit battery expansion. Nonetheless, it has little effect in improving the thermal stability. Furthermore, in the present disclosure, by controlling the doping amounts and valences of the elements A and B, a balance between the thermal stability, expansion and cycling performance is achieved, thereby enabling lithium cobalt oxide to operate at higher charging voltages.

The element A is one or more elements selected from the group consisting of Mg, Sc, Ti, Fe, Ni, Cu, Zn, Ga, Zr, Nb, Mo, Ru, Rh, Pd, In, Sn, Hf, Ta, W, Re, Cr, Y, Sb, Lu, Au, Pb, and Er.

In specific selection, in order to enable the element A to move to the position of Li in the charge and discharge process, and thus act to prevent collapse of the structure and improve the thermal stability, the element A is selected to have an ionic radius that is close to the ionic radius of lithium. As used herein, the term “close” means the difference between the ionic radii is equal to or less than 20%, more preferably equal to or less than 18%, still more preferably equal to or less than 16%, most preferably equal to or less than 14%. Because the ionic radius of an element may vary with its valence, coordination number and the like, the ionic radius as used herein refers to the ionic radius of the element A or lithium ion after the elements A, B and the valences thereof have been determined.

The element A in LiCo_{(1-α-β)}A_{(α)}B_{(β)}O₂ has an average valence of 1.5-3.5, preferably 2.0-3.0. When the average valence of the element A in the present disclosure is in the above range, the layered structure of the lithium cobalt oxide will be more stable during cycling, and thus the positive electrode material exhibits superior stability in charge/discharge cycles. If the average valence of the element A in the positive electrode material is outside of this range, the cycling performance will be degraded.

The element B is one or more elements selected from the group consisting of Na, Al, Si, Ge, Mn, Ca, Te, Hg, Bi, La, Ce, Pr, Nd, Sm and V.

In specific selection, in order to prevent the element B from moving to the position of Li, improve the cycling performance and inhibit the battery expansion while the crystalline structure is stabilized, the element B is selected to have an ionic radius that is largely different from the radius of lithium. As used herein, the term “largely different” means the difference between the ionic radii is equal to or more than 25%, more preferably equal to or more than 27%, still more preferably equal to or more than 29%, most preferably equal to or more than 31%. Because the ionic radius of an element may vary with its valence, coordination number and the like, the ionic radius as used herein refers to the ionic radius of the element B or lithium ion after the elements A, B and the valences thereof have been determined.

The element B in LiCo_{(1-α-β)}A_{(α)}B_{(β)}O₂ has an average valence of 2.0-4.0, preferably 2.5-3.5. When the average valence of the element B in the present disclosure is in the above range, the layered structure of the lithium cobalt oxide will be more stable during cycling, and thus the positive electrode material exhibits superior stability in charge/discharge cycles. If the average valence of the element B in the positive electrode material is outside of this range, the cycling performance will be degraded.

In LiCo_{(1-α-β)}A_{(α)}B_{(β)})O₂, based on the total moles of the elements A, B and cobalt, the total doping amount (α+β) of the elements A and B meets 0.1 mol %≤α+β≤8 mol %, preferably 0.2 mol %≤α+β≤7 mol %, more preferably 0.5 mol %≤α+β≤6 mol %, still more preferably 1 mol %≤α+β≤5 mol %.

The doping amount α of the element A meets 0.05 mol %≤α≤5 mol %. If the doping amount α of the element A is higher than 5 mol %, the phase structure of the lithium cobalt oxide may be affected by the existence of the excessive amount of the element A; if the doping amount α of the element A is lower than 0.05 mol %, the existence of the insufficient amount of the element A will be unable to prevent structure collapse or improve thermal stability by movement of the element A to the position of Li in the charge and discharge process. The doping amount α of the element A is preferably 0.2 mol %≤α≤3 mol %, more preferably 0.4 mol %≤α≤2.5 mol %, and still more preferably 0.6 mol %≤α≤2 mol %.

The doping amount β of the element B meets 0.05 mol %≤β≤5 mol %. If the doping amount β of the element B is higher than 5 mol %, the phase structure of the lithium cobalt oxide may be affected by the existence of the excessive amount of the element B; if the doping amount β of the element B is lower than 0.05 mol %, the existence of the insufficient amount of the element B will be unable to stabilize the crystalline structure. The doping amount β of the element B is preferably 0.2 mol %≤α≤3 mol %, more preferably 0.4 mol %≤α≤2.5 mol %, and still more preferably 0.6 mol %≤α≤2 mol %.

In the positive electrode active material particles according to the present disclosure, the elements A and B may have different distribution modes.

The element A is required to be able to move to the position of Li in the charge and discharge process. Hence, the element A may be uniformly distributed in the positive electrode active material particles, so that it can move uniformly in the charge and discharge process to prevent structure collapse and improve thermal stability.

In the charge and discharge process, the element B is not required to move to the position of Li. As long as the concentration of the element B on the surface of the particles reaches a certain value, the function of the element B in stabilizing the crystalline structure can be realized. Therefore, the element B may have a greater concentration on the particle surface than inside the particle.

A cobalt source solution and an element B source solution in a proportion are added to a precipitant solution at certain rates respectively. After completion of the reaction, washing, filtration, baking and calcination are performed to obtain a precursor of a positive electrode active material. By controlling the feeding rate of the element B source solution, the element B has a concentration on a particle surface greater than that inside the particle by 20% or more.

The above precursor is mixed with lithium carbonate in a certain molar ratio, and an element A source is added in a proportion. The resulting mixture is blended homogeneously in a mixer. After the mixing, the above material is calcined in a baking furnace, and then broken and sieved to obtain the positive electrode active material of the present disclosure.

Since the positive electrode active material thus obtained has a granular morphology on a microscopic scale, the positive electrode active material is also called positive electrode active material particles in the present disclosure. In addition, the positive electrode active material particles may also be surface-coated as desired.

In order to allow the positive electrode active material to exhibit good performances in a charge and discharge process, the positive electrode active material particles may be surface-coated in addition to the bulk doping that is aimed to inhibit structural phase change in the course of charge and discharge. An ideal coating material should be stable. In other words, it should be insoluble in an electrolyte system and resistant to damage at high electric potentials. At the same time, it should have good conductivity for electrons and lithium ions to facilitate electron conduction within an electrode and diffusion of lithium ions.

In the present disclosure, materials that are generally used to coat the surface of positive electrode active material particles may be used, including, for example, carbon; elemental silver; metal oxides such as Al₂O₃, MgO, TiO₂, ZnO, ZrO₂, SiO₂, CeO₂, La₂O₃, RuO₂; lithium-containing composite oxides such as Li₄Ti₅O₁₂, LoMn₅O₁₂, Li₂O-2B₂O₃, La₂O₃/Li₂O/TiO₂, Li₂ZrO₃, LiAlO₂; lithium free composite oxides such as Y₃Al₅O₁₂, 3LaAlO₃:Al₂O₃, ZrTiO₄, MgAlO₄, 8 mol % Y₂O₃-92 mol % ZrO₂; fluorides such as AlF₃; hydroxides such as Al(OH)₃; phosphates such as AlPO₄, Co₃(PO₄)₂; silicates such as MnSiO₄; polymers such as conductive polypyrrole (PPy); etc.

As a method for coating the surface of positive electrode active material particles, any method that is generally used to coat the surface of positive electrode active material particles may be used. The method is not particularly limited so long as surface coating of the positive electrode active material particles can be fulfilled. Vapor deposition, organic pyrolysis, precipitation, sol-gel method and chemical plating may be exemplified.

The positive electrode active material particles of the present disclosure may have an average particle size (D₅₀) of 5 μm-30 μm, preferably 8 μm-25 μm, more preferably 10 μm-22 μm. In particular, if the average particle size (D₅₀) is less than 5 μm, the fine positive electrode active material particles will lead to an increased specific surface, so that more binder will be needed, thereby reducing the capacity of a battery when the volume of the battery is not changed. If the average particle size (D₅₀) is greater than 30 μm, the battery efficiency per unit weight will decrease due to the unduly large size of the particles.

The average particle size (D₅₀) is defined as a 50% limit in a particle size distribution. It may be determined using a method that is generally used to measure a particle size, such as laser diffraction.

In the case that the positive electrode active material particles of the present disclosure are surface-coated, the surface coating is assumed as a part of the positive electrode active material when the particle size is measured. The thickness of the surface coating may be determined by a skilled person in the art based on the actual situation. For example, the thickness may be 50 nm-100 nm.

The positive electrode for a lithium ion secondary battery according to the present disclosure is one that is prepared by coating a positive electrode current collector with a slurry comprising the positive electrode active material particles of the present disclosure, a conductive material and a binder. In particular, for example, the positive electrode for a lithium ion secondary battery may be prepared by coating a positive electrode current collector with a positive electrode slurry which is formulated by mixing a positive electrode active material consisting of positive electrode active material particles, a conductive material, a binder and, if desired, a filler. As defined above and below, the positive electrode for a lithium ion secondary battery according to the present disclosure has a bulk density of greater than 3.8 g/cc.

Except for the use of the positive electrode active material particles of the present disclosure, a method that is generally used to prepare a positive electrode for a lithium ion secondary battery may be used to prepare the positive electrode for a lithium ion secondary battery according to the present disclosure. This is known to a skilled person in the art, and may be modified appropriately in light of practical needs.

The positive electrode current collector generally has a thickness of 3 μm to 201 μm. The positive electrode current collector is not particularly limited. A positive electrode current collector that is generally used for a lithium ion secondary battery may be used without particular limitation so long as it causes no chemical change in the battery and has a high electric conductivity. For example, stainless steel, aluminum, nickel, titanium, as well as aluminum or stainless steel that is surface treated with carbon, nickel, titanium or silver may be used. In addition, fine protrusions and dimples may be formed in the surface of the positive electrode current collector to enhance adhesion of the positive electrode active material thereto, and a film, a sheet, a foil, a web, a porous structure, a foam, a non-woven cloth and the like may be used.

The positive electrode active material of the present disclosure may comprise only the positive electrode active material particles of the present disclosure, but it may comprise other positive electrode active material particles additionally. In particular, examples include, but are not limited to, layered compounds such as lithium nickel oxide (LiNiO₂) or those compounds substituted with one or more transitional metal elements; lithium manganese oxides such as those represented by chemical formula Li₁₊ₓMn₂₋ₓO₄ (wherein x is 0-0.33), LiMnO₃, LiMn₂O₃, LiMnO₂ and the like; lithium copper oxide (Li₂CuO₂); vanadium oxides such as LiV₃O₈, LiV₃O₄, V₂O₅, Cu₂V₂O₇ and the like; Ni site type lithium nickel oxides represented by chemical formula LiNi₁₋ₓMₓO₂ (wherein M=Co, Mn, Al, Cu, Fe, Mg, B or Ga, x=0.01-0.3); lithium manganese composite oxides represented by chemical formula LiMn₂₋ₓMₓO₂ (wherein M=Co, Ni, Fe, Cr, Zn or Ta, x=0.01-0.1) or Li₂Mn₃MO₈ (wherein M=Fe, Co, Ni, Cu or Zn); LiMn₂O₄ in which Li in the chemical formula is partially substituted with alkaline earth metal ions; disulfide compounds, Fe₂(MoO₄)₃; etc.

The conductive material used in the positive electrode of the present disclosure may be one that is generally used in a positive electrode for a lithium ion secondary battery. The conductive material is not limited to any particular type so long as it causes no chemical change in the battery and is electrically conductive. For example, use may be made of graphites such as natural or artificial graphite; carbon black matters such as carbon black, acetylene black, Ketjen black, channel black, furnace black, lamp black, pyrolysis carbon black; conductive fibers such as carbon fibers or metal fibers; metal powders such as fluorocarbon powder, aluminum powder, nickel powder; conductive whiskers such as zinc oxide whiskers, potassium titanate whiskers; conductive metal oxides such as titanium oxide; polyphenylene derivatives; etc.

In the present disclosure, based on a total weight of a positive electrode slurry comprising a positive electrode active material, the conductive material is generally added in a proportion of 0.1-30 wt %.

A binder that is generally used in a positive electrode for a lithium ion secondary battery may be used as a binder that the positive electrode of the present disclosure comprises. The binder is not particularly limited so long as it contributes to the adhesion between the active material and the conductive material as well as the adhesion of the active material to current collector. For example, use may be made of polyvinylidene fluoride, polyvinyl alcohol, carboxymethyl cellulose (CMC), starch, hydroxypropyl cellulose, regenerated cellulose, polyvinylpyrrolidone, tetrafluoroethylene, polyethylene, polypropylene, ethylene-propylene-diene terpolymer (EPDM), sulfonated EPDM, butadiene styrene rubber, fluororubber, various copolymers, etc.

In the present disclosure, based on a total weight of a positive electrode slurry comprising a positive electrode active material, the binder is generally added in a proportion of 0.1-30 wt %.

The lithium ion secondary battery of the present disclosure is consisting of a positive electrode, a negative electrode, a separator and an electrolyte, wherein the positive electrode uses the positive electrode of the present disclosure as described above. By using the positive electrode of the present disclosure, a lithium ion secondary battery, which has good cycling performance and thermal stability at high charging voltages and can inhibit expansion of the secondary battery, may be obtained. In particular, by using the positive electrode of the present disclosure as described above as the positive electrode, the lithium ion secondary battery of the present disclosure can achieve a full battery charging voltage of equal to or greater than 4.40 V, or a positive electrode charging potential of equal to or greater than 4.45 V versus a Li/Li⁺ redox electron pair, while the cycling performance, thermal stability and expansion inhibition are sustained or improved.

Except for the use of the positive electrode comprising the positive electrode active material of the present disclosure, a method that is generally used to prepare a lithium ion secondary battery may be used to prepare the lithium ion secondary battery of the present disclosure. This is known to a skilled person in the art, and may be modified appropriately in light of practical needs.

The components other than the positive electrode in the lithium ion secondary battery are described as follows.

The negative electrode is prepared by coating a negative electrode current collector with a negative electrode active material and drying. If desired, the negative electrode may further selectively comprise one or more ingredients contained in the above positive electrode.

The negative electrode current collector generally has a thickness of 3 μm to 500 μm. The negative electrode current collector is not particularly limited so long as it causes no chemical change in the battery and is electrically conductive. For example, copper, stainless steel, aluminum, nickel, titanium, sintered carbon, as well as aluminum or stainless steel that is surface treated with carbon, nickel, titanium or silver, aluminum-cadmium alloy and the like may be used. In addition, just like the positive electrode current collector, fine protrusions and dimples may be formed in the surface of the negative electrode current collector to enhance adhesion of the negative electrode active material thereto, and a film, a sheet, a foil, a web, a porous structure, a foam, a non-woven cloth and the like may be used.

As negative electrode active materials, use may be made of carbon such as non-graphitized carbon, graphitized carbon; metal composite oxides such as LiₓFe₂O₃ (0≤x≤1), LiₓWO₂ (0≤x≤1), SnₓMe₁₋ₓMe′_{y}O_{z} (Me: Mn, Fe, Pb, Ge; Me′: Al, B, P, Si, elements of Groups I, II, III in the periodic table, halogens; 0<x≤1; 1≤y≤3; 1≤z≤8); lithium metal; lithium alloys; silicon based alloys; tin based alloys; metal oxides such as SnO, SnO₂, PbO, PbO₂, Pb₂O₃, Pb₃O₄, Sb₂O₃, Sb₂O₄, Sb₂O₅, GeO, GeO₂, Bi₂O₃, Bi₂O₄ and Bi₂O₅; conductive polymers such as polyacetylene; Li—Co—Ni based materials; etc.

An electrolyte for a lithium ion secondary battery is a non-aqueous lithium salt electrolyte consisting of a non-aqueous electrolyte, a lithium salt and an additive.

As the non-aqueous electrolyte, use may be made of a non-aqueous electrolyte that is generally used in a lithium ion secondary battery, such as a non-aqueous organic solvent, an organic solid electrolyte, an inorganic solid electrolyte, etc, but the non-aqueous electrolyte is not limited thereto. In particular, use may be made of non-aqueous organic solvents such as N-methyl-2-pyrrolidone, propylene carbonate, ethylene carbonate, butylene carbonate, dimethyl carbonate, diethyl carbonate, γ-butyrolactone, 1,2-dimethoxy ethane, tetrahydrofuran, 2-methyl tetrahydrofuran, dimethylsulfoxide, 1,3-dioxolane, formamide, dimethylformamide, dioxolane, nitromethane, methyl formate, methyl acetate, phosphoric acid triester, trimethoxy methane, dioxolane derivatives, sulfolane, methyl sulfolane, 1,3-dimethyl-2-imidazolidinone, propylene carbonate derivatives, tetrahydrofuran derivatives, ethers, methyl propionate, ethyl propionate; organic solid electrolytes such as polyethylene derivatives, polyethylene oxide derivatives, polypropylene oxide derivatives, phosphoric acid ester polymers, poly agitation lysine, polyester sulfides, polyvinyl alcohols, polyvinylidene fluoride, and polymers containing ionic dissociation groups; inorganic solid electrolytes such as nitrides, halides and sulfates of lithium such as Li₃N, LiI, Li₅NI₂, Li₃N—LiI—LiOH, LiSiO₄, LiSiO₄—LiI—LiOH, Li₂SiS₃, Li₄SiO₄, Li₄SiO₄—LiI—LiOH and Li₃PO₄—Li₂S—SiS₂. These non-aqueous electrolytes may be used alone or in a combination of two or more of them.

As the lithium salt, use may be made of a lithium salt that is generally used in a lithium ion secondary battery, such as LiClO₄, LiAsF₆, LiBF₄, LiCF₃SO₃, LiPF₆, LiCl, LiI, LiBr, LiCF₃CO₂, LiSbF₆, LiAlCl₄, CH₃SO₃Li, CF₃SO₃Li, (CF₃SO₂)₂NLi, etc. The lithium salt in the non-aqueous electrolyte may have a concentration of 0.5-2 mol/L. These lithium salts may be used alone or in a combination of two or more of them.

An additive may further be added to the electrolyte. Generally, various additives may be added in light of the other components and practical needs.

In particular, in order to improve charge/discharge characteristics and flame retardancy, pyridine, triethyl phosphite, triethanolamine, cyclic ethers, ethylenediamine, n-glyme, hexaphosphoric triamide, nitrobenzene derivatives, sulfur, quinone imine dyes, N-substituted oxazolidinone, N,N-substituted imidazolidine, ethylene glycol dialkyl ethers, ammonium salts, pyrrole, 2-methoxy ethanol, aluminum trichloride or the like may be added. In order to impart incombustibility, halogen-containing solvents such as carbon tetrachloride and trifluoroethylene may be added. In order to improve high-temperature storage characteristics, carbon dioxide gas, fluoroethylene carbonate (FEC), propene sultone (PRS), and the like may be added. In order to improve conductivity, acetamide, methyl acetamide, ethyl acetamide and the like may be added. These additives may be used alone or in a combination of two or more of them.

In order to form an effective protective film on the positive electrode surface to cover the active sites and reduce the reactivity of the positive electrode with the electrolyte, a nitrile additive such as butyronitrile, valeronitrile, n-heptanenitrile, succinonitrile, glutaronitrile, adiponitrile, pimelonitrile, 1,2,3-propanetricarbonitrile, 1,3,5-pentanetricarbonitrile, hexane trinitrile or the like is preferably added to the electrolyte of the present disclosure. These nitrile additives may be used alone or in a combination of two or more of them. The nitrile additives also include phosphazene additives, such as hexamethyl phosphazene, hexachlorocyclotriphosphazene, and ethoxypentafluorocyclotriphosphazene. These phosphazene additives may be used alone or in a combination of two or more of them. Based on the total weight of an electrolyte comprising a lithium salt, a nitrile additive is added in a proportion of 0.2-10 wt %, preferably 1-9 wt %, more preferably 2-8 wt %, most preferably 3-7 wt %.

Better effects may be resulted by further matching a nitrile additive with a lithium salt in an electrolyte. For example, when the lithium salt in an electrolyte is LiPF₆, use of a dinitrile additive will afford better effects.

The separator is disposed between a positive electrode and a negative electrode. An insulating film having high ion permeability and mechanical strength is used as the separator. In general, the separator has a pore diameter of 0.01-10 μm, and a thickness of 5-300 μm. As an example of the separator, a sheet or non-woven cloth made from chemically resistant, hydrophobic olefinic polymers such as polypropylene, glass fiber or polyethylene may be used. When a solid electrolyte such as a polymer is used as the electrolyte, the solid electrolyte may also serve as a separator.

The lithium ion secondary battery described above has good cycling performance and thermal stability at high charging voltages, and can inhibit expansion of the secondary battery. Therefore, the energy density of the lithium ion secondary battery may be increased effectively, and a higher charge capacity may be provided.

The lithium ion secondary battery of the present disclosure may be further made into a battery pack and a device comprising the battery pack. Since such a battery pack and a device using the battery pack are known in the art, and their structures, manufacturing methods and uses are known to an ordinary person skilled in the art, they will not be described in detail redundantly herein.

The device may be selected from but not limited to the group consisting of a notebook computer, a netbook computer, a tablet computer, a mobile phone, MP3, a wearable electronic device, a power tool, an electric vehicle (EV), a hybrid electric vehicle (HEV), a plug-in hybrid electric vehicle (PHEV), an electric bike (E-bike), an electric scooter (E-scooter), an electric self-balancing scooter, an electric golf cart, and a system for storing electric power.

The starting materials in the Examples are all commercially available, and the instruments used in the Examples are common instruments in the art. A skilled person in the art is able to choose suitable starting materials and instruments based on common knowledge.

In the Examples, the capacity per gram of the positive electrode, coulombic efficiency, cycling performance, high-temperature storage performance, and thermal stability are evaluated using the methods conventionally used in the art for performance evaluation. A skilled person in the art knows the specific operations, and is able to choose suitable starting materials and instruments based on common knowledge to implement the operations.

### Example 1

Step 1: A 1 mol/L cobalt sulfate solution, a 0.004 mol/L aluminum chloride solution, and a 0.001 mol/L manganese chloride solution were formulated, each in a volume of 1 L. To an ammonium bicarbonate solution, cobalt sulfate was added at a rate of 0.5 L/h. At the same time, aluminum chloride and manganese chloride were first added at a rate of 0.35 L/h for 1 h, and then at 0.65 L/h to the mixed solution for 1 h. Based on the total moles of the cobalt, aluminum and manganese, the total amount of aluminum chloride that was added was 0.4 mol %, and the total amount of manganese chloride that was added was 0.1 mol %. The mixed solution was allowed to react with a sodium hydroxide precipitant for a period of time, and then the resulting precipitate was washed with deionized water till the filtrate was neutral. After the filtration, the precipitate was dried and calcined to 800° C. to obtain a positive electrode active material precursor.

Step 2: The precursor was mixed with lithium carbonate at a weight ratio of 2.1:1, and the resulting mixture was doped with elements magnesium, titanium and nickel, the sources of which were magnesium oxide, titanium dioxide and nickel oxide, wherein the doping amounts of the elements based on moles were 0.8 mol % for magnesium, 0.2 mol for titanium and 0.2 mol % for nickel. The above mixture was blended uniformly in a mixer. After the blending, the above material was placed in a baking furnace and calcined to 1000° C. After the calcination, the material was broken and sieved through a 200 mesh sieve. By way of the above treatment, the lithium cobalt oxide based positive electrode active material of this Example was obtained.

Ethylene carbonate, propylene carbonate and diethyl carbonate were mixed at a mass ratio of 1:1:1 to provide a solvent to which a lithium salt, lithium hexafluorophosphate, was added to formulate a mixed solution having a concentration of 1.1 mol/L based on the amount of the electrolyte. Succinonitrile was added in an amount that was 3 wt % of the total weight of the solvent and the lithium salt. The electrolyte of this Example was thus obtained. This electrolyte was infused into a cell comprising a positive electrode sheet, a separator and a negative electrode sheet but without an electrolyte. A lithium secondary battery was prepared according to a conventional manufacturing method, and the battery of Example 1 was thus obtained.

The battery of Example 1 prepared from the above positive electrode active material and electrolyte was evaluated for its performances, including the capacity per gram of the positive electrode, coulombic efficiency, cycling performance, high-temperature storage performance, and thermal stability.

### Example 2

The lithium cobalt oxide based positive electrode active material of this Example was prepared using the same manufacturing process as that in Example 1, only except that the doping elements were regulated. In comparison with Example 1, the doping elements in Step 1 were aluminum and silicon, wherein aluminum chloride was an aluminum source and doped in an amount of 1.5 mol %; and ethyl orthosilicate was a silicon source and doped in an amount of 0.2 mol %. The doping elements in Step 2 were magnesium, titanium and nickel, wherein magnesium oxide was a magnesium source and doped in an amount of 1 mol %; titanium dioxide was a titanium source and doped in an amount of 0.2 mol %; and nickel oxide was a nickel source and doped in an amount of 0.2 mol %.

The composition of the electrolyte in this Example was the same as that in Example 1.

The secondary battery prepared from the above positive electrode active material and electrolyte was evaluated for its performances, including the capacity per gram of the positive electrode, coulombic efficiency, cycling performance, high-temperature storage performance, and thermal stability.

### Example 3

The lithium cobalt oxide based positive electrode active material of this Example was prepared using the same manufacturing process as that in Example 2.

The type of the electrolyte, the concentration of the lithium salt and the type of the additive were the same as those in Example 1, wherein succinonitrile was added in a proportion of 5 wt %.

The secondary battery prepared from the above positive electrode active material and electrolyte was evaluated for its performances, including the capacity per gram of the positive electrode, coulombic efficiency, cycling performance, high-temperature storage performance, and thermal stability.

### Example 4

The lithium cobalt oxide based positive electrode active material of this Example was prepared using the same manufacturing process as that in Example 1, only except that the doping elements were regulated. In comparison with Example 1, the doping elements in Step 1 were aluminum and manganese, wherein aluminum chloride was an aluminum source and doped in an amount of 0.8 mol %; and manganese chloride was a manganese source and doped in an amount of 0.2 mol %. The doping elements in Step 2 were magnesium, titanium and nickel, wherein magnesium oxide was a magnesium source and doped in an amount of 0.8 mol %; titanium dioxide was a titanium source and doped in an amount of 0.2 mol %; and nickel oxide was a nickel source and doped in an amount of 0.2 mol %.

The type of the electrolyte, the concentration of the lithium salt and the type of the additive were the same as those in Example 1, wherein succinonitrile was added in a proportion of 0.1 wt %.

The secondary battery prepared from the above positive electrode active material and electrolyte was evaluated for its performances, including the capacity per gram of the positive electrode, coulombic efficiency, cycling performance, high-temperature storage performance, and thermal stability.

### Example 5

The lithium cobalt oxide based positive electrode active material of this Example was prepared using the same manufacturing process as that in Example 4.

The type of the electrolyte, the concentration of the lithium salt and the type of the additive were the same as those in Example 1, wherein succinonitrile was added in a proportion of 12 wt %.

The secondary battery prepared from the above positive electrode active material and electrolyte was evaluated for its performances, including the capacity per gram of the positive electrode, coulombic efficiency, cycling performance, high-temperature storage performance, and thermal stability.

### Comparative Example 1

The lithium cobalt oxide based positive electrode active material of this Comparative Example was prepared using the same manufacturing process as that in Example 1, but no metal element other than cobalt was added in Steps 1 and 2.

The composition of the electrolyte in this Comparative Example is the same as that in Example 1 except that succinonitrile was not included.

The secondary battery prepared from the above positive electrode active material and electrolyte was evaluated for its performances, including the capacity per gram of the positive electrode, coulombic efficiency, cycling performance, high-temperature storage performance, and thermal stability.

### Comparative Example 2

The lithium cobalt oxide based positive electrode active material of this Comparative Example was prepared using the same manufacturing steps and parameters as those in Example 1, but the aluminum chloride solution and manganese chloride solution were added for one time at a rate of 0.5 L/h in Step 1. The dopants and their proportions in Step 2 were completely the same as those in Example 1. In this Comparative Example, aluminum and manganese were distributed uniformly in the lithium cobalt oxide particles.

The composition of the electrolyte in this Comparative Example was the same as that in Example 1.

The secondary battery prepared from the above positive electrode active material and electrolyte was evaluated for its performances, including the capacity per gram of the positive electrode, coulombic efficiency, cycling performance, high-temperature storage performance, and thermal stability.

The compositions of the batteries in Examples 1-5 and Comparative Examples 1-2 are shown in Table 1.

TABLE 1

| | Total Doping | Total Doping | | |
|---|---|---|---|---|
| | Amount of | Amount of | Distribution of | Nitrile Amount |
| | Element A | Element B | Element B | in Electrolyte |
| Unit | mol % | mol % | — | wt % |
| Ex. 1 | 1.2 | 0.5 | More on surface | 3% |
| | | | than inside | |
| Ex. 2 | 1.4 | 1.7 | More on surface | 3% |
| | | | than inside | |
| Ex. 3 | 1.4 | 1.7 | More on surface | 5% |
| | | | than inside | |
| Ex. 4 | 1.2 | 1 | More on surface | 0.1% |
| | | | than inside | |
| Ex. 5 | 1.2 | 1 | More on surface | 12% |
| | | | than inside | |
| Comp. | 0 | 0 | None | 0% |
| Ex. 1 | | | | |
| Comp. | 1.2 | 0.5 | Uniform | 3% |
| Ex. 2 | | | distribution | |

The results of the performance evaluation on the secondary batteries in Examples 1-5 and Comparative Examples 1-2 shown in Table 1 are listed in Table 2.

TABLE 2

| | | | Cycle | | | | |
|---|---|---|---|---|---|---|---|
| | | | Retention | Expansion | | Bulk | |
| | | | Rate | After | | Density | |
| | | First | After | Stored at | Thermal | of | Full |
| | | Coulombic | 100 | 60° C. for 7 | Decomposition | Electrode | Battery |
| | Capacity | Efficiency | Cycles | days | Temperature | Sheet | Voltage |
| Unit | mAh/g | % | % | % | ° C. | g/cc | V |
| Ex. 1 | 190.2 | 96.7 | 92.4% | 4.9% | 221 | 4.0 | 4.45 V |
| Ex. 2 | 188.6 | 95.6 | 93.5% | 3.8% | 243 | 4.0 | 4.45 V |
| Ex. 3 | 188.3 | 95.3 | 93.2% | 3.4% | 243 | 4.0 | 4.45 V |
| Ex. 4 | 189.4 | 96.2 | 92.8% | 5.2% | 228 | 4.0 | 4.45 V |
| Ex. 5 | 189.3 | 96.1 | 91.4% | 4.3% | 228 | 4.0 | 4.45 V |
| Comp. Ex. 1 | 191.8 | 97.3 | 48.6% | 23.4% | 186 | 4.0 | 4.45 V |
| Comp. Ex. 2 | 190.0 | 96.6 | 89.7% | 6.1% | 218 | 4.0 | 4.45 V |

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

What is claimed is:

1. A positive electrode active material for a lithium ion secondary battery, comprising:
a material represented by LiCo_{(1-α-β)}A_{(α)}B_{(β)}O₂, wherein
element A is selected from the group consisting of Mg, Sc, Ti, Fe, Ni, Cu, Zn, Ga, Zr, Nb, Mo, Ru, Rh, Pd, In, Sn, Hf, Ta, W, Re, Cr, Y, Sb, Lu, Au, Pb, Er and combinations thereof, and element B is selected from the group consisting of Na, Al, Si, Ge, Mn, Ca, Te, Hg, Bi, La, Ce, Pr, Nd, Sm, V and combinations thereof;
a difference between an ionic radius of the element A and an ionic radius of lithium is equal to or less than 20%, and a difference between an ionic radius of the element B and the ionic radius of lithium is equal to or more than 25%;
a total doping amount (α+β) of the elements A and B satisfies 0.1 mol %≤α+β≤8 mol %, a doping amount α of the element A satisfies 0.05 mol %≤α≤5 mol %, and a doping amount β of the element B satisfies 0.05 mol %≤β≤5 mol %;
an average valence of the element A is from 1.5 to 3.5, and an average valence of the element B is from 2.0 to 4.0;
the element A is uniformly distributed in particles of the positive electrode active material; and
the element B has a higher concentration on a surface of the particles than an inside of the particles.

2. A positive electrode for a lithium ion secondary battery, wherein the positive electrode includes the positive electrode active material according to claim 1.

3. The positive electrode according to claim 2, wherein the positive electrode has a bulk density of greater than 3.8 g/cc.

4. The positive electrode according to claim 2,
wherein the positive electrode includes a current collector.

5. The positive electrode according to claim 4,
wherein the current collector has a thickness from 3 μm to 201 μm.

6. The positive electrode according to claim 2,
wherein the positive electrode includes a binder having a weight percentage from 0.1 wt % to 30 wt %.

7. A lithium ion secondary battery, wherein the lithium ion secondary battery includes the positive electrode active material according to claim 1.

8. The lithium ion secondary battery according to claim 7, wherein the lithium ion secondary battery includes an electrolyte including nitriles in an amount of 0.2-10%.

9. The lithium ion secondary battery according to claim 8, wherein the electrolyte includes a non-aqueous lithium salt electrolyte.

10. The lithium ion secondary battery according to claim 9, wherein the non-aqueous lithium salt electrolyte includes a non-aqueous electrolyte, a lithium salt and an additive.

11. The lithium ion secondary battery according to claim 7, wherein the lithium ion secondary battery includes a separator.

12. The lithium ion secondary battery according to claim 11, wherein the separator has a pore diameter from 0.01 μm to 10 μm, and a thickness from 5 μm to 300 μm.

13. The lithium ion secondary battery according to claim 7, wherein the lithium ion secondary battery has a full battery charging voltage of equal to or greater than 4.40 V.

14. The lithium ion secondary battery according to claim 13, wherein the lithium ion secondary battery has a charging potential of equal to or greater than 4.45 V versus a Li/Li⁺ redox electron pair.
